(19) United States
(12) Patent Application Publication
(10) Pub. No.: US 2014/0339330 A1
(43) Pub. Date: Nov. 20, 2014

(54) SOURCE GAS JETTING NOZZLE FOR A VACUUM DEPOSITION APPARATUS

(71) Applicant: AbyzR Co., Ltd., Hwaseong-si (KR)

(72) Inventors: Taekwon Hong, Seongnam-si (KR); Jaebok Song, Seoul (KR)

(73) Assignee: AbyzR Co., Ltd., Hwaseong-si (KR)

(21) Appl. No.: 14/275,852

(22) Filed: May 12, 2014

(30) Foreign Application Priority Data
May 14, 2013 (KR) 10-2013-0054555

(51) Int. Cl. B05B 1/00

(52) U.S. Cl. CPC B05B 1/005
USPC 239/133; 239/589.1

(57) ABSTRACT

Disclosed is a source gas jetting nozzle which includes a connection pipe having a portion connected to a source gas supplier, a first gas pipe including a communication hole communicating with the connection pipe by connecting to one end of the connection pipe and a first jetting hole, the communication hole and the first jetting hole being formed on the outer surface of the first gas pipe, and a second gas pipe including the first gas pipe inside the second gas pipe, and including a first insertion hole for inserting a predetermined part of the connection pipe to connect the one end of the connection pipe to the communication hole of the first gas pipe, and a second jetting hole for jetting the source gas introduced from the first gas pipe.

### CROSS-REFERENCE TO RELATED APPLICATION

This application claims the benefit of Korean Patent Application No. 10-2013-0054555, filed on May 14, 2013, which is hereby incorporated by reference as if fully set forth herein.

### BACKGROUND OF THE INVENTION

1. Field of the Invention

The present invention relates to a source gas jetting nozzle for a vacuum deposition apparatus, and more particularly, to a source gas jetting nozzle for a vacuum deposition apparatus, in which a source gas is introduced into the center of a gas pipe and more jetting holes for jetting the source gas are formed nearer to both ends of the gas pipe, thereby jetting the source gas uniformly onto a surface of a substrate.

2. Discussion of the Related Art

In general, a vacuum deposition apparatus deposits a thin film on a substrate using a source gas generated by vaporizing a source material. More specifically, the vacuum deposition apparatus vaporizes the source material in vacuum and deposits the thin film on the substrate by jetting the resulting source gas onto the substrate through a jetting nozzle.

A conventional vacuum deposition apparatus includes a first gas pipe having jetting holes formed on its outer surface, for transferring a source gas and jetting the source gas through the jetting holes, and a second gas pipe for jetting the source gas introduced from the first gas pipe onto a surface of a substrate. The first gas pipe is connected, at its portion, to a source gas supplier and receives the source gas from the source gas supplier. The density of the jetting holes is increased farther from the portion of the first gas pipe connected to the source gas supplier or the jetting holes are densely populated at the center of the first gas pipe. Thus, the source gas flowing in the first gas pipe is introduced into the second gas pipe through the jetting holes and then jetted onto the surface of the substrate.

However, in the case where the density of the jetting holes increases farther from the portion of the first gas pipe connected to the source gas supplier, more of the source gas is jetted from the portion of the first gas pipe connected to the source gas supplier than from the other portion of the first gas pipe, which is not connected to the source gas supplier. On the other hand, in the case where the jetting holes are densely populated at the center of the first gas pipe, more of the source gas is jetted from the center of the first gas pipe than from both ends of the first gas pipe. Due to the non-uniform jetting of the source gas from the first gas pipe, the jetting nozzle has limitations in uniformly jetting the source gas onto the surface of the substrate.

### SUMMARY OF THE INVENTION

Accordingly, the present invention is directed to a source gas jetting nozzle for a vacuum deposition apparatus that substantially obviates one or more problems due to limitations and disadvantages of the related art.

An object of the present invention is to provide a source gas jetting nozzle for a vacuum deposition apparatus, which can uniformly distribute a source gas across a substrate.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a source gas jetting nozzle for a vacuum deposition apparatus includes a connection pipe having a portion connected to a source gas supplier for supplying a source gas, a first gas pipe including a communication hole communicating with the connection pipe by connecting to one end of the connection pipe and a first jetting hole for jetting the source gas introduced through the connection pipe, the communication hole and the first jetting hole being formed on the outer surface of the first gas pipe, and a second gas pipe including the first gas pipe inside the second gas pipe, and including a first insertion hole for inserting a predetermined part of the connection pipe to connect the one end of the connection pipe to the communication hole of the first gas pipe, and a second jetting hole for jetting the source gas introduced from the first gas pipe, the first insertion hole and the second jetting hole being formed on an outer surface of the second gas pipe.

The connection pipe may be connected to a sub gas supplier at a predetermined position of an outer surface of the connection pipe.

The communication hole may be formed at a center of the outer surface of the first gas pipe along a longitudinal direction of the first gas pipe.

A plurality of first jetting holes may be formed on the outer surface of the first gas pipe, and a density of the plurality of first jetting holes may increase farther from the communication hole.

The source gas jetting nozzle may further include a first heater included inside the first gas pipe, and a temperature sensor included inside the first gas pipe, apart from the first heater by a predetermined distance.

The first jetting hole and the second jetting hole may face each other with the first heater in between.

The first gas pipe and the second gas pipe may be made of quartz.

The source gas jetting nozzle may further include a third gas pipe including the second gas pipe inside of the third gas pipe, and including a second insertion hole for selectively inserting the connection pipe and a third jetting hole for jetting the source gas introduced from the second gas pipe, the second insertion hole and the third jetting hole being formed on an outer surface of the third gas pipe.

The communication hole and the first jetting hole may face each other with the first heater in between, the first jetting hole and the second jetting hole may face each other with the first heater in between, and the second jetting hole and the third jetting hole may face each other with the first heater in between.

The first insertion hole may be formed on a center of the outer surface of the second gas pipe along a longitudinal direction of the second gas pipe.

A plurality of second jetting holes may be formed on the outer surface of the second gas pipe, and a density of the plurality of second jetting holes may increase farther from the first insertion hole.

The source gas jetting nozzle may further include a second heater disposed at a predetermined position of the outer surface of the third gas pipe.

The first gas pipe, the second gas pipe, and the third gas pipe may be made of quartz.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view of a source gas jetting nozzle for a vacuum deposition apparatus according to an embodiment of the present invention;

FIG. 2 is a sectional view of the source gas jetting nozzle for a vacuum deposition apparatus, taken along line II-II illustrated in FIG. 1 according to the embodiment of the present invention;

FIG. 3 is a plan view of a first gas pipe illustrated in FIG. 1;

FIG. 4 is a sectional view of a source gas jetting nozzle for a vacuum deposition apparatus according to another embodiment of the present invention;

FIG. 5 is a sectional view of the source gas jetting nozzle for a vacuum deposition apparatus, taken along line V-V illustrated in FIG. 4 according to the second embodiment of the present invention; and

FIG. 6 is a plan view of a second gas pipe illustrated in FIG. 4.

### DETAILED DESCRIPTION OF THE INVENTION

The objectives and effects of the present invention and the technical configurations of the present invention to achieve them will be apparent with reference to embodiments of the present invention described in detail with the attached drawings. A detailed description of a generally known function and structure of the present invention will be avoided lest it should obscure the subject matter of the present invention. Although the terms used in the present invention are selected from generally known and used terms, taking into account the structures, roles, and functions of the present invention, they are subject to change depending on the intention of a user or an operator or practices.

It is to be clearly understood that the present invention may be implemented in various manners, not limited to embodiments as set forth herein. The embodiments of the present invention are provided only to render the disclosure of the present invention comprehensive and indicate the scope of the present invention to those skilled in the art. The present invention is defined only by the appended claims. Accordingly, the scope of the invention should be determined by the overall description of the specification.

Through the specification, when it is said that some part “includes” a specific element, this means that the part may further include other elements, not excluding them, unless otherwise mentioned.

With reference to the attached drawings, a source gas jetting nozzle for a vacuum deposition apparatus according to an embodiment of the present invention will be described below in detail.

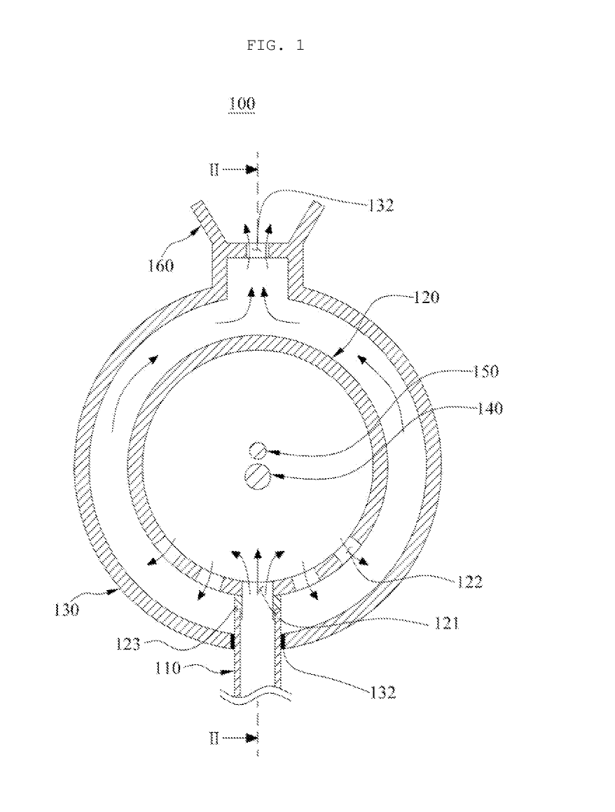

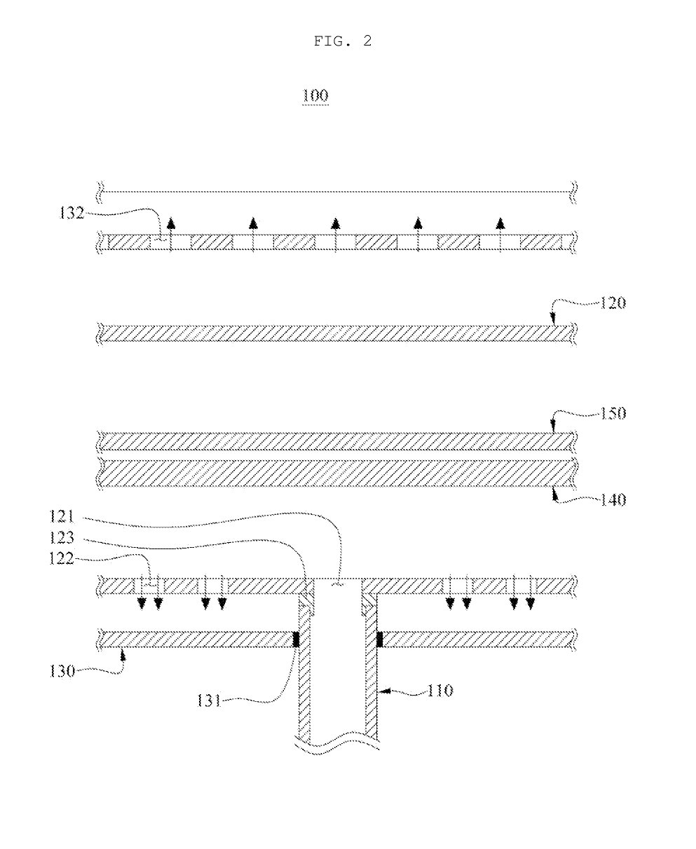

FIG. 1 is a sectional view of a source gas jetting valve 100 for a vacuum deposition apparatus according to an embodiment of the present invention, and FIG. 2 is a sectional view of the source gas jetting valve 100 for a vacuum deposition apparatus, taken along line II-II illustrated in FIG. 1 according to the embodiment of the present invention.

Referring to FIGS. 1 and 2, the source gas jetting valve 100 for a vacuum deposition apparatus according to an embodiment of the present invention may be configured to include a connection pipe 110 connected, at its one portion, to a source gas supplier (not shown), a first gas pipe 120, and a second gas pipe 130. The first gas pipe 120 includes a communication hole 121 connected to one end of the connection pipe 110 and communicating with the connection pipe 110 and a first jetting hole 122 for jetting the source gas introduced through the communication hole 121 and the connection pipe 110, which are formed on an outer surface of the first gas pipe 120. The second gas pipe 130 accommodates the first gas pipe 120 inside it and includes a first insertion hole 131 for inserting a predetermined part of the connection pipe 110 in order to connect the end of the connection pipe 110 to the communication hole 121, and a second jetting hole 132 for jetting the source gas introduced through the first insertion hole 131 and the first gas pipe 120, which are formed on an outer surface of the second gas pipe 130.

The connection pipe 110 may be formed into the shape of a pillar. For example, the connection pipe 110 may be shaped into a square pillar or a cylinder. For the convenience of description, the following description will be given with the appreciation that the connection pipe 110 is cylindrical, by way of example.

The connection pipe 110 may be formed into a cylinder. Both surfaces of the connection pipe 110 may be opened. The source gas supplier may be connected to one opened surface of the connection pipe 110. Thus, the source gas supplied from the source gas supplier may be introduced into the connection pipe 110 and then may be discharged outside the connection pipe 110 through the other opened surface of the connection pipe 110.

The connection pipe 110 may be connected, at a predetermined position of its outer surface, to a sub gas supplier (not shown) for supplying an additional gas. The additional gas supplied from the sub gas supplier may be introduced into the connection pipe 110. Thus, the source gas and the additional gas may be introduced and mixed in the connection pipe 110. For the convenience of description, the following description will be given with the appreciation that only the source gas is introduced into the connection pipe 110.

The first gas pipe 120 may be formed into the shape of a pillar. For example, the first gas pipe 120 may be shaped into a square pillar or a cylinder. For the convenience of description, the following description will be given with the appreciation that the first gas pipe 120 is cylindrical, by way of example.

The first gas pipe 120 may be formed into a cylinder. The communication hole 121 may be formed at the center of the outer surface of the first gas pipe 120 along the longitudinal direction of the first gas pipe 120. The communication hole 121 may connect with the other opened surface of the connection pipe 110. To connect with the communication hole 121, the connection pipe 110 may be selectively engaged with the first gas pipe 120. For example, the first gas pipe 120 may further include a communication hole 123 extended from the communication hole 110. As the connection pipe 110 is selectively engaged with the communication hole 123, the connection pipe 110 may connect with the communication hole 121, which should not be construed as limiting the present invention. Further, the present invention may include any component and structure that can selectively engage the connection pipe 110 with the first gas pipe 120 so that the connection pipe 110 may connect with the communication hole 121.

As the connection pipe 110 connects with the communication hole 121, the source gas discharged from the connection pipe 110 may be introduced into the first gas pipe 120. The first gas pipe 120 may be made of quartz with high thermal stability. Accordingly, distortion of the first gas pipe 120 caused by the source gas generated at high temperature can be prevented.

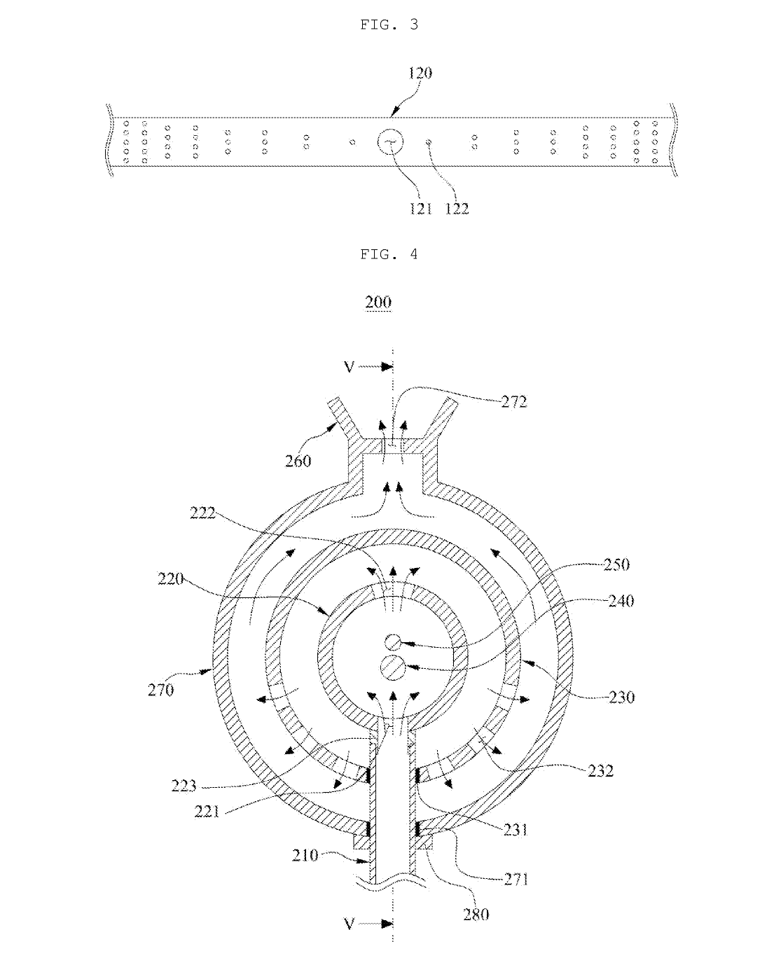

FIG. 3 is a plan view of the first gas pipe 120 illustrated in FIG. 1.

Referring to FIG. 3, the first jetting hole 122 may be formed on the outer surface of the first gas pipe 120. The first jetting hole 122 may be formed on the outer surface of the first gas pipe 120, in the vicinity of the communication hole 121. Herein, a plurality of first jetting holes 122 may be formed on the outer surface of the first gas pipe 120. Further, the plurality of first jetting holes 122 may be formed on the outer surface of the first gas pipe 120 in such a manner that the density of the first jetting holes 120 increases farther from the communication hole 121. That is, the plurality of first jetting holes 121 may be formed in triangles on the outer surface of the first gas pipe 120. The first gas pipe 120 may jet the source gas uniformly through the plurality of first jetting holes 122 along the longitudinal direction of the first gas pipe 120.

More specifically, since the communication hole 121 is formed at the center of the outer surface of the first gas pipe 120, the pressure of the source gas introduced into the first gas pipe 120 may be highest at the center of the first gas pipe 120. Herein, more first jetting holes 122 may be formed at both ends of the first gas pipe 120 than at the center of the first gas pipe 120. That is, although the source gas is introduced with the highest pressure at the center of the first gas pipe 120, a small amount of the source gas may be discharged from the center of the first gas pipe 120 because a smaller number of first jetting holes 122 are formed at the center of the first gas pipe 120. On the contrary, the source gas may be introduced into both ends of the first gas pipe 120 at a relatively low pressure level. However, since more first jetting holes 121 are formed at both ends of the first gas pipe 120, the first gas pipe 120 may discharge a large amount of the source gas through the first jetting holes 121 formed at both ends of the first gas pipe 120. Since the source gas is introduced into the center of the first gas pipe 120 at a higher pressure level than into both ends of the first gas pipe 120, similar amounts of the source gas may be discharged from the center and both ends of the first gas pipe 120. Consequently, the source gas can be discharged uniformly along the longitudinal direction of the first gas pipe 120.

The source gas jetting nozzle 100 for a vacuum deposition apparatus may further include a first heater 140. The first heater 140 may be included inside the first gas pipe 120. The first heater 140 may be included inside the first gas pipe 120, apart from an inner surface of the first gas pipe 120 by a predetermined distance. Being included in the gas pipe 120, the first heater 140 may transfer a predetermined amount of heat to the source gas flowing through the first gas pipe 120. The first heater 140 may include a heat line inside it to generate a predetermined amount of heat, to which the present invention is not limited. Further, the present invention may include any component and device for generating heat in the first heater 140.

That is, the first heater 140 may compensate for heat loss that occurs while the source gas introduced into the first gas pipe 120 is being jetted through the first jetting holes 122. Therefore, the source gas flowing through the first gas pipe 120 may be kept at a predetermined temperature. Due to the resulting unchanged energy state, the source gas can be maintained stable.

The first heater 140 may be divided into a predetermined number of sections along the longitudinal direction of the first gas pipe 120 and temperature may be controlled independently in each section of the first heater 140. Accordingly, the source gas jetting nozzle 100 for a vacuum deposition apparatus according to the present invention can readily compensate for heat loss of the source has flowing through the first gas pipe 120.

The source gas jetting nozzle 100 for a vacuum deposition apparatus may further include a temperature sensor 150. The temperature sensor 150 may be included inside the first gas pipe 120, apart from the first heater 140 by a predetermined distance. The temperature sensor 150 may measure inner temperatures of the first gas pipe 120. The temperature sensor 150 may measure inner temperatures of the first gas pipe 120 in which the sections of the first heater 140 are disposed.

The temperature sensor 150 may measure the inner temperatures of the first gas pipe 120 and thus may generate temperature data. A user may receive the temperature data from the temperature sensor 150 and control each section of the first heater 140 by checking the inner temperatures of the first gas pipe 120 corresponding to the sections of the first heater 140. Therefore, the source gas jetting nozzle 100 for a vacuum deposition apparatus according to the present invention can more effectively compensate for heat loss of the source gas introduced into the first gas pipe 120.

The second gas pipe 130 may be formed into the shape of a pillar. For example, the second gas pipe 130 may be shaped into a square pillar or a cylinder but not limited to the examples. For the convenience of description, the following description will be given with the appreciation that the second gas pipe 130 is cylindrical, by way of example.

The second gas pipe 130 may be formed into a cylinder. The second gas pipe 130 may be hollow inside it. A cross section of the second gas pipe 130 may have a larger diameter than a cross section of the first gas pipe 120. Thus, the first gas pipe 120 may be included inside the second gas pipe 130 and the source gas jetted from the first gas pipe 120 may be introduced into a space between the outer surface of the first gas pipe 120 and an inner surface of the second gas pipe 130. The second gas pipe 130 may be made of quartz with high thermal stability. Accordingly, distortion of the second gas pipe 130 caused by the temperature of the source gas introduced from the first gas pipe 120 can be prevented.

The first insertion hole 131 may be formed on the outer surface of the second gas pipe 130. The first insertion hole 131 may penetrate through the outer surface of the second gas pipe 130. A predetermined part of the connection pipe 110 may be inserted into the second gas pipe 130 through the first insertion hole 131. The predetermined part of the connection pipe 110 inserted into the second gas pipe 130 may be connected to the communication hole 121 of the first gas pipe 120.

The second jetting hole 132 may be formed on the outer surface of the second gas pipe 130. The second jetting hole 132 and the first jetting hole 122 may be formed respectively at the outer surfaces of the second gas pipe 130 and the first gas pipe 120, facing each other with the first heater 140 in between. Further, the second jetting hole 132 and the first insertion hole 131 may be formed on the outer surface of the second gas pipe 130, facing each other with the first heater 140 in between. Consequently, since the source gas is jetted from the first jetting hole 122 and the second jetting hole 132 in opposite directions, the source gas may flow along a maximum path in the source gas jetting nozzle 100 for a vacuum deposition apparatus, thereby increasing the uniformity of the source gas jetted from the source gas jetting nozzle 100 for a vacuum deposition apparatus.

The second jetting hole 132 may be extended on the outer surface of the second gas pipe 130 along the longitudinal direction of the second gas pipe 130. Or a plurality of second jetting holes 132 may be formed on the outer surface of the second gas pipe 130, apart from each other by a predetermined distance along the longitudinal direction of the second gas pipe 130. However, the present invention is not limited to the above examples. The second gas pipe 130 may jet the source gas onto a substrate (not shown) placed under the second jetting holes 132. As described before, the first gas pipe 120 can jet the source gas into the second gas pipe 130 along the longitudinal direction. Thus, the second gas pipe 130 can jet the source gas uniformly through the second jetting holes 132. As the second gas pipe 130 jets the source gas uniformly along the longitudinal direction, the source gas jetting nozzle 100 for a vacuum deposition apparatus according to the present invention can jet the source gas uniformly onto one surface of the substrate placed under the second gas pipe 130.

The source gas jetting nozzle 100 for a vacuum deposition apparatus according to the present invention further includes a jetting shade 160. The jetting shade 160 may be formed on the outer surface of the second gas pipe 130. The jetting shade 160 may be stretched out at a predetermined angle with respect to the outer surface of the second gas pipe 130. The jetting shade 160 may guide a direction in which the source gas jetted from the second jetting holes 132 is spread. Therefore, the source gas jetting valve 100 for a vacuum deposition apparatus can effectively jet the source gas onto the substrate.

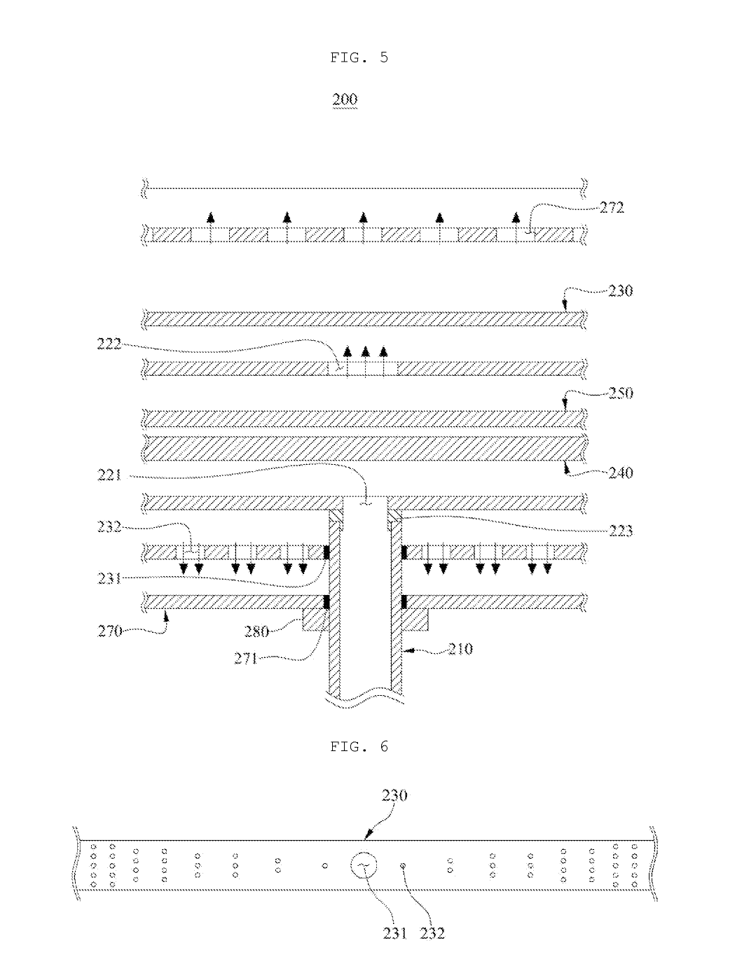

FIG. 4 is a sectional view of a source gas jetting valve 200 for a vacuum deposition apparatus according to another embodiment of the present invention, and FIG. 5 is a sectional view of the source gas jetting valve 200 for a vacuum deposition apparatus, taken along line V-V illustrated in FIG. 4 according to the embodiment of the present invention.

The following description will focus mainly on the difference between the source gas jetting valves 100 and 200 for a vacuum deposition apparatus according to the embodiments of the present invention.

Referring to FIGS. 4 and 5, a connection pipe 210 may be formed into the shape of a pillar having both surfaces opened. A source gas supplier may be connected to one opened surface of the connection pipe 210. Thus, the source gas supplied from the source gas supplier may be introduced into the connection pipe 210 through the one opened surface of the connection pipe 210 and then may be discharged outside the connection pipe 210 through the other opened surface of the connection pipe 210. The connection pipe 210 may be connected, at a predetermined position of its outer surface, to a sub gas supplier (not shown) for supplying an additional gas. The additional gas supplied from the sub gas supplier may be introduced into the connection pipe 210. The source gas and the additional gas may be introduced and mixed in the connection pipe 210. Therefore, the connection pipe 210 may discharge the mixture of the source gas and the additional gas through the other opened surface of the connection pipe 210. For the convenience of description, the following description will be given with the appreciation that only the source gas is introduced into the connection pipe 210.

A communication hole 221 may be formed at the center of the outer surface of a first gas pipe 220 along the longitudinal direction of the first gas pipe 220. The communication hole 221 may connect with the other opened surface of the connection pipe 210. The source gas discharged from the other opened surface of the connection pipe 210 may be introduced into the first gas pipe 220 through the communication hole 221.

A first jetting hole 222 may be formed on the outer surface of the first gas pipe 220. The first jetting hole 222 and the communication hole 221 may be formed on the outer surface of the first gas pipe 220, facing each other with a first heater 240 in between. The first gas pipe 220 may jet the introduced source gas through the first jetting hole 222.

The source gas jetting nozzle 200 for a vacuum deposition apparatus may further include the first heater 240. The first heater 240 may be included inside the first gas pipe 220 to transfer a predetermined amount of heat to the source gas introduced into the first gas pipe 220. The source gas jetting nozzle 100 for a vacuum deposition apparatus according to the present invention may further include a temperature sensor 250 included inside the first gas pipe 220, apart from the first heater 240 by a predetermined distance. The temperature sensor 250 may measure inner temperatures of the first gas pipe 220 in which the first heater 240 is disposed and thus may generate temperature data.

A second gas pipe 230 may be formed into the shape of a pillar and may accommodate the first gas pipe 220 inside it. Thus, the source gas jetted from the first gas pipe 220 may be introduced into a space between the outer surface of the first gas pipe 220 and an inner surface of the second gas pipe 230.

A first insertion hole 231 may be formed on the outer surface of the second gas pipe 230, for inserting a predetermined part of the connection pipe 210 in order to connect one end of the connection pipe 210 to the communication hole 221 of the first gas pipe 220.

A second jetting hole 232 may be formed on the outer surface of the second gas pipe 230. The second jetting hole 232 and the first jetting hole 222 may be formed respectively on the outer surfaces of the second gas pipe 230 and the first gas pipe 220, facing each other with the first heater 240 in between. Therefore, the source gas may flow along a maximum path in the source gas jetting nozzle 200 for a vacuum deposition apparatus.

FIG. 6 is a plan view of the second gas pipe 230 illustrated in FIG. 4.

Referring to FIG. 6, the second jetting hole 232 may be formed on the outer surface of the second gas pipe 230, in the vicinity of the first insertion hole 231. Herein, a plurality of second jetting hole 232 may be formed on the outer surface of the second gas pipe 230. The plurality of second jetting hole 232 may be formed on the outer surface of the second gas pipe 230 in such a manner that the density of the second jetting holes 232 increases farther from the first insertion hole 231. That is, the plurality of second jetting holes 232 may be formed in triangles on the outer surface of the second gas pipe 230. The second gas pipe 230 may jet the source gas uniformly along the longitudinal direction of the second gas pipe 230 through the plurality of second jetting holes 232.

More specifically, the pressure of the source gas jetted into the second gas pipe 230 may be highest at the center of the second gas pipe 230. Herein, more second jetting holes 232 may be formed at both ends of the second gas pipe 230 than at the center of the second gas pipe 230. That is, although the source gas is introduced with the highest pressure at the center of the second gas pipe 230, a small amount of the source gas may be jetted through a plurality of second jetting holes 232 formed at the center of the second gas pipe 230 because a small number of second jetting holes 232 are formed at the center of the second gas pipe 230. On the contrary, the source gas may be introduced into both ends of the second gas pipe 230 at a relatively low pressure level. However, since more second jetting holes 232 are formed at both ends of the second gas pipe 230, the second gas pipe 230 may discharge a large amount of the source gas through the second jetting holes 232 formed at both ends of the second gas pipe 230. Since the source gas is introduced into the center of the second gas pipe 230 at a higher pressure level than into both ends of the second gas pipe 103, similar amounts of the source gas may be discharged from the second jetting holes 232 at the center and both ends of the second gas pipe 230. Consequently, the source gas can be discharged uniformly along the longitudinal direction of the second gas pipe 230.

The source gas jetting nozzle 200 for a vacuum deposition apparatus according to the present invention further includes a third gas pipe 270. The third gas pipe 270 may be formed into the shape of a pillar. For example, the third gas pipe 270 may be shaped into a square pillar or a cylinder. For the convenience of description, the following description will be given with the appreciation that the third gas pipe 270 is cylindrical, by way of example.

The third gas pipe 270 may be formed into a cylinder. A cross section of the third gas pipe 270 may have a larger diameter than a cross section of the second gas pipe 230. Thus, the second gas pipe 230 may be included inside the third gas pipe 270 and the source gas jetted from the second gas pipe 230 may be introduced into a space between the outer surface of the second gas pipe 230 and an inner surface of the third gas pipe 270. The third gas pipe 270 may be made of quartz with high thermal stability. Accordingly, distortion of the third gas pipe 270 caused by the temperature of the source gas introduced from the second gas pipe 230 can be prevented.

A second insertion 271 may be formed on the outer surface of the third gas pipe 270. A predetermined part of the connection pipe 210 may be inserted into the third gas pipe 270 through the second insertion hole 271. The predetermined part of the connection pipe 210 inserted into the third gas pipe 270 may be inserted into the second gas pipe 230.

A third jetting hole 272 may be formed on the outer surface of the third gas pipe 270. The third jetting hole 272 may be extended on the outer surface of the third gas pipe 270 along the longitudinal direction of the third gas pipe 270. Or a plurality of third jetting holes 272 may be formed on the outer surface of the third gas pipe 270, apart from each other by a predetermined distance along the longitudinal direction of the third gas pipe 270. However, the present invention is not limited to the above examples. For the convenience of description, the following description will be given in the context of a plurality of third jetting holes 272 spaced from each other by a predetermined distance along the longitudinal direction of the third gas pipe 270 on the outer surface of the third gas pipe 270.

The plurality of third jetting holes 272 may be formed on the outer surface of the third gas pipe 270. The third gas pipe 270 may jet the source gas onto a substrate placed under it through the plurality of third jetting holes 272. As described before, the second gas pipe 230 may jet the source gas uniformly into the third gas pipe 270 along the longitudinal direction. Therefore, the third gas pipe 270 may jet the source gas uniformly onto the substrate placed under it through the plurality of third jetting holes 272 along the longitudinal direction.

The third jetting holes 272 and the second jetting hole 232 may be formed respectively on the outer surfaces of the third and second gas pipes 270 and 230, facing each other with the first heater 240 in between. Consequently, since the source gas is jetted from the second jetting hole 232 and the third jetting holes 272 in opposite directions, the source gas may flow along a longer path in the source gas jetting nozzle 200 for a vacuum deposition apparatus, thereby increasing the uniformity of the source gas jetted from the source gas jetting nozzle 200 for a vacuum deposition apparatus. In addition, the uniform jetting of the source gas onto the substrate leads to an increased quality of a thin film formed by jetting the source gas.

The source gas jetting valve 200 for a vacuum deposition apparatus further includes a jetting shade 260. The jetting shade 260 may be formed on the outer surface of the third gas pipe 270. The jetting shade 260 may be stretched out at a predetermined angle with respect to the outer surface of the third gas pipe 270. The jetting shade 260 may guide a direction in which the source gas jetted from the third jetting holes 272 is spread. Therefore, the source gas jetting valve 200 for a vacuum deposition apparatus can effectively jet the source gas onto the substrate.

The source gas jetting valve 200 for a vacuum deposition apparatus further includes a second heater 280. The second heater 280 may be disposed at a predetermined position of the outer surface of the third gas pipe 270. The second heater 280 may transfer a predetermined amount of heat to the third gas pipe 270. The second heater 280 may include a heat line for generating a predetermined amount of heat inside it, which should not be construed as limiting the present invention. Further, the present invention may include any component and device for generating heat in the second heater 280. As the second heater 280 transfers a predetermined amount of heat to the outer surface of the third gas pipe 270, the predetermined amount of heat may be transferred to the source gas flowing inside the third gas pipe 270. That is, since the predetermined amount of heat generated from the second heater 280 is transferred to the source gas through the third gas pipe 270, heat loss caused by the flow of the source gas through the third gas pipe 270 can be prevented. Therefore, the source gas flowing through the third gas pipe 270 is kept at a predetermined temperature. The resulting unchanged energy state maintains the source gas stable.

As is apparent from the above description, because a source gas supplied through the communication hole formed at the center of the outer surface of the first gas pipe is jetted through the plurality of first jetting holes formed with a higher density farther from the communication hole on the outer surface of the first gas pipe in the source gas jetting nozzle for a vacuum deposition apparatus according to the embodiments of the present invention, the source gas can be discharged uniformly along the longitudinal direction of the first gas pipe. Therefore, the source gas jetting nozzle for a vacuum deposition apparatus according to the embodiments of the present invention can jet the source gas uniformly onto a substrate placed under the second gas pipe.

Further, as the source gas jetting nozzle for a vacuum deposition apparatus according to the embodiments of the present invention jets the source gas uniformly, a thin film can be formed to a uniform thickness on the substrate.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. A source gas jetting nozzle for a vacuum deposition apparatus, comprising:
a connection pipe having a portion connected to a source gas supplier for supplying a source gas;
a first gas pipe including a communication hole connected with the connection pipe by connecting to one end of the connection pipe and a first jetting hole for jetting the source gas introduced through the connection pipe, the communication hole and the first jetting hole being formed on the outer surface of the first gas pipe; and
a second gas pipe including the first gas pipe inside of the second gas pipe, a first insertion hole for inserting a predetermined part of the connection pipe to connect the one end of the connection pipe to the communication hole of the first gas pipe, and a second jetting hole for jetting the source gas introduced from the first gas pipe, wherein the first insertion hole and the second jetting hole are formed on an outer surface of the second gas pipe.

2. The source gas jetting nozzle according to claim 1, wherein the connection pipe is connected to a sub gas supplier at a predetermined position of an outer surface of the connection pipe.

3. The source gas jetting nozzle according to claim 1, wherein the communication hole is formed at a center of the outer surface of the first gas pipe along a longitudinal direction of the first gas pipe.

4. The source gas jetting nozzle according to claim 3, wherein a plurality of first jetting holes is formed on the outer surface of the first gas pipe, and
wherein a density of the plurality of first jetting holes increases farther from the communication hole.

5. The source gas jetting nozzle according to claim 1, further comprising:
a first heater included inside the first gas pipe; and
a temperature sensor included inside the first gas pipe, apart from the first heater by a predetermined distance.

6. The source gas jetting nozzle according to claim 5, wherein the first jetting hole and the second jetting hole face each other with the first heater in between.

7. The source gas jetting nozzle according to claim 1, wherein the first gas pipe and the second gas pipe are made of quartz.

8. The source gas jetting nozzle according to claim 5, further comprising a third gas pipe including the second gas pipe inside of the third gas pipe, and a second insertion hole for selectively inserting the connection pipe and a third jetting hole for jetting the source gas introduced from the second gas pipe, wherein the second insertion hole and the third jetting hole are formed on an outer surface of the third gas pipe.

9. The source gas jetting nozzle according to claim 8, wherein the communication hole and the first jetting hole face each other with the first heater in between, the first jetting hole and the second jetting hole face each other with the first heater in between, and the second jetting hole and the third jetting hole face each other with the first heater in between.

10. The source gas jetting nozzle according to claim 8, wherein the first insertion hole is formed on a center of the outer surface of the second gas pipe along a longitudinal direction of the second gas pipe.

11. The source gas jetting nozzle according to claim 10, wherein a plurality of second jetting holes are formed on the outer surface of the second gas pipe,
wherein a density of the plurality of second jetting holes is increased farther from the first insertion hole.

12. The source gas jetting nozzle according to claim 8, further comprising a second heater disposed at a predetermined position of the outer surface of the third gas pipe.

13. The source gas jetting nozzle according to claim 8, wherein the first gas pipe, the second gas pipe, and the third gas pipe are made of quartz.
